(19) United States
(12) Patent Application Publication
(10) Pub. No.: US 2004/0177025 A1
(43) Pub. Date: Sep. 9, 2004

(54) Real-time recommendations

(76) Inventors: Daniel J. Spoonhower, Pittsburgh, PA (US); Daniel P. Huttenlocher, Ithaca, NY (US); Brian M. Freyburger, New York, NY (US); William J. Rucklidge, Mountain View, CA (US); Tracey Jaquith, Lafayette, CA (US); Walter W. Bell, San Francisco, CA (US)

Correspondence Address: Stephen C. Durant, Morrison & Foerster LLP, 425 Market Street, San Francisco, CA, 94105-2482, US

(21) Appl. No.: 10/378,012

(22) Filed: Feb. 27, 2003

(51) Int. Cl. G06F 17/60

(52) U.S. Cl. 705/37

(57) ABSTRACT

A computer-implemented method of finding a complementary set of parties to begin a negotiation for a trade in an item comprising: creating respective user models, based upon one or more external market factors, to respectively predict behavior of one or more respective users with respect to participation in a transaction in the item; evaluating current external market conditions with respect to the item; based upon respective user models and results of the current external market evaluation, respectively predicting respective current conditions in which respective users are likely to participate in transactions in the item; identifying respective users with respective complementary current conditions; notifying at least one respective user of the existence of at least one other user predicted to currently be likely to be willing to participate in a transaction in the item on conditions that are complementary to conditions on which such at least one notified user is likely to be willing to participate in a transaction in the item.

### BACKGROUND OF THE INVENTION

In so-called illiquid or thinly-traded marketplaces (i.e. those were volume is relatively low and pricing is not easily apparent, for example the U.S. corporate bond market or the mortgage-backed securities market), participants may be unwilling to place orders because of the difficulty of judging the market value of the securities to be traded. Also, because orders are rare in such markets, even an indication of willingness to buy or sell may cause a shift in the market; this causes orders to become even more infrequent. Because there are so few orders at any one time, current order flow cannot be used as the sole means of finding other interested parties. Nor can it alone be used to determine the market value of a security.

As used herein, an electronic marketplace comprises a computer system which accepts orders over an electronic network, stores orders on computer-readable media and computes matches electronically. It may also transmit current open orders (ranked appropriately) via a network as well as records of past orders and trades previously stored on its media. Marketplaces maybe open to any and all participants or only to select members. Also, they maybe symmetric (in that all participants are treated equally) or asymmetric (in that some participants are treated specially). Many symmetric marketplaces are anonymous (in that the identity of other participants are hidden even after a trade occurs). Participant identity is one of the more important aspects of an asymmetric marketplace: the privileged participant(s) may be sole holders of the identities of all other participants. Examples of electronic marketplaces include exchanges, both open and member-based (exchanges typically charges fees per transaction or for membership). Electronic marketplaces may also take the shape of a broker/dealer that transmits its markets and accepts orders from its customers electronically. In this later case, the marketplace may be used as a tool to facilitate communication, manage orders, automatically execute trades, and analyze results.

A number of methods focus on using other data, typically historical, to model market behavior. Past orders, if available, and past trades can be used as an indication of the current and future value of a security. These methods use historical data to detect trends in the movement of prices over time; by extrapolating these trends to the present and future, they may attempt to determine the current market value of the security.

### BRIEF DESCRIPTION OF THE DRAWINGS

FIG. 1 is an illustrative block diagram of one system in which the invention can be implemented.

FIG. 2 is an illustrative block diagram of an alternative system in which the invention can be implemented.

### DETAILED DESCRIPTION OF THE PREFERRED EMBODIMENT

The following description is presented to enable any person skilled in the art to make and use the invention, and is provided in the context of particular applications and its requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the are would realize that the invention might be practiced without the use of these specific details. In other instances, well known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

One challenge of illiquid markets is finding complementary sets of parties to execute trades. This is especially true of those markets with thousands (or tens of thousands) of instruments and thousands of participants. Order and trade volume are small and participants may be wary of advertising interest for a variety of reasons. Some participants, especially brokers, may attempt to predict the behavior of others in order to complete more transactions, for example, by narrowing the field to those parties who are most likely to participate. Other participants may also benefit from a better understanding of the relative interest of other parties and the prices at which they are likely to trade.

Historical participation, including orders and trades, is a good indication of a party's current and future interest. However, accounting for current market conditions is also critical in finding those participants who are most likely to commit to a transaction. Real-time Recommendations use both historical and current data to proactively alert participants and direct them to those parts of the market in which they are most likely to trade.

Historical data can be used to predict future behavior of individual market participants. In a simple case, a purchase yesterday by a particular user may indicate a desire to purchase more today by that same user if the price has gone down. On the other hand, it may indicate a desire to sell if the price has gone up. For example, say that a given user purchased 2000 shares of the stock QQQ yesterday at $24. If the market price is now $23, then a model can be developed for this user's behavior. For example, the model might predict that, whatever motivated the user to buy QQQ yesterday, coupled with an even lower price might, convince the user to purchase more QQQ. Conversely, that same model might predict that if the price has gone up, say to $25, then the user might be easily convinced to sell the QQQ shares and take a profit of $2000.

Thus, producing a model that predicts user behavior involves assigning to or associating with a user, information determined to represent the profile of a trade that user is predicted to find to be desirable based upon that user's behavior. this information can be encoded into a computer readable medium for use in making real time recommendations to other prospective users. Such information may include price, quantity or direction, for example. Ideally, such information should be useful in formulating a proposed trade so that the information can be used as a basis to seek out one or more other users with a complementary user models, e.g., with complementary price/quantity/direction information. Once such user models have been created for a plurality of users, it may be possible to present to one or more complementary users prioritized lists of prospective complementary trades, including predicted price/quantity/direction, information for example, with the mostly likely participants given higher priority in the list.

Analyses used to predict user behavior and to create user models may take into account history from many securities. For example, convertibles with the same underlying security may be treated similarly, and orders placed in one may indicate interest in another. For example, if a user has previously placed an order to buy the convertible bond QQQ 5.5 '09 (i.e. the convertible bond issued by QQQ with a yield of 5.5%, maturing in 2009 and with the option to convert to QQQ common shares) at 99.75, a Real-Time Recommendation System in accordance with an embodiment of the invention might develop a model of that user that predicts that he is also likely to be willing to buy QQQ 4 '10 (i.e. another bond with a similar option) at 99.75.

Securities may also be grouped by the type of issuing institution (e.g. companies in the same sector). For example, if a Real-Time Recommendation system observes that a given user has sold the stock of a semi-conductor manufacturer at a price-to-earnings ratio of 30, then it can use the earnings figures of other semi-conductor manufacturers to predict the user's price for those stock (e.g. if the earnings per share of another such manufacturer is $0.50, then it can create a model of this user that estimates that this user would be willing to sell that stock at $15 per share).

Moreover, securities may also be grouped based upon similar characteristics (e.g. bonds with similar yields). For example, users are often willing to accept a wide range of mortgage-backed securities with similar characteristics, for example, maturity date and yield. A Real-time Recommendation system can use past orders and trades to predict what specific characteristics a given user is looking for. In this case, a “model estimate” of a user might not only include a price, quantity and direction, but also arbitrary other characteristics of the securities themselves (e.g. yield).

A Real-Time Recommendation system in accordance with one embodiment of the invention uses historical data along with current market conditions to adjust its models of participant behavior. For example, in markets where one instrument is hedged against another, the price of one security is often closely related to that of the other. The system uses current market conditions for one security to adjust price estimates for another. Specifically, it notes market conditions when orders and trades were entered and accounts for changes in those conditions over time.

As an example, consider the U.S. convertible bond market. In the convertibles market, the term “market conditions” refers the current equity market prices. When an order is placed, the current equity prices are recorded, along with the user's relative valuation of the convertible security and the underlying equity. As the underlying equity price changes, the convertible price estimate is adjusted accordingly. These adjusted prices are then made available to users, sorted with the most aggressive estimates first. By “most aggressive” it is meant mean either the buyer with the highest price or the seller with lowest price.

In addition to price estimates for each participant, a Real-Time Recommendation system in accordance with an embodiment of the invention also may evaluate what an estimate of current market value of the security. This evaluation is useful when targeting securities for which there is no national quote. For example, if there is no standard quoting mechanism for the marketplace (e.g. NASDAQ), the current market value may be computed by taking the weighted average of the most recent trades of all market participants. This value can be used to determine which participants are likely to have interest that is relevant to the current market; participants whose estimated prices are too far from the current value are ignored.

A system in accordance with the invention can offer a variety of configurations so that it may be effectively applied to securities with varying characteristics. In particular, the system may be configured to ignore small orders, to ignore small changes in market conditions and set what prices are deemed relevant to current market values. The may also be configured to use only orders in determining the current market value of the security, only recent trades, or a weighted combination of orders and trades.

A Real-Time Recommendations system of the invention can proactively notify prospective participants when the forecasted interest of two parties complement each other, even if there is no current order flow. of possible trading opportunities. Notifications may take place in any of a variety of different ways such as through email, “instant message” (e.g. Yahoo Instant Messenger), or a “pop-up” window accompanied by an audible alert, to name just a few examples. As used herein, two orders “complement” each other if there is a trade that meets the constraints imposed by each. It is assumed that the prospectively matched users already communicate electronically with the marketplace, either directly from a computer or indirectly through some other person, and that the system and process of an embodiment of the present invention can use this same electronic mechanism.

For example, if the models indicate that one participant is likely to buy at a price higher than another is likely to sell, a broker may decide to contact both parties to see if a transaction is possible. Rather than requiring such a user to continually scan all securities, the system may be configure to indicates only those securities in which a transaction is likely.

In the previous case, there were no active participants: a security was recommended based only upon historical order and trade data. By contrast, if there is one active participant, the system can provide another type of notification. Rather than notifying a broker of an opportunity to bring two end-participants together, it can notify a single participant of an opportunity for an immediate execution. One example of this sort of “activity” is an open order. When a new order is entered, the system and process of an embodiment of the invention compares the price of that order to the price estimates of all other participants. If a potential match is found, the matching participants are notified immediately; they are shown a recommendation for the open order. It will be appreciated that one or more of the participants may be a broker.

Note that while the price estimates are based on only historical order and trade data, the order recommendations require the presence of an active participant in the marketplace.

In the example above, the system and process of the invention embodiment is not only recommending a security but a specific order which is likely to be of interest to the user.

The recommendation is presented in real-time (i.e. while the order is still live) so that the notified user may take action immediately.

Another form of historical data not mentioned above is position data, in other words the current contents of the user's portfolio. Like historical order and trade data, position information can be used to predict the behavior of market participants. By understanding where securities are currently being held, the system and process can make more accurate predictions of who is likely to sell those securities. Also, the system and process can take advantage of “hedging” information, or the desired ratio between the quantities of two securities held by a user. By noting where users are off-hedge (i.e. where ratio between the quantities of two securities in the user's portfolio has drifted from some ideal ratio defined by the user) the system can proactively notify those users of opportunities to get back on-hedge.

In addition, one embodiment of the system uses feedback from users to determine where its models are inaccurate. Users may indicate that a recommended security or order is not something they are interested in. This indication is then used by the system to remove that user from the set of likely participants for that security, preventing future recommendations.

Once the system has identified and notified a user of an order or marketplace of interest, the user may be presented with one or more options to take action upon that recommendation. For example, say that there is an outstanding order to sell QQQ at $25, and the system has determined that a given user has been modeled as being likely to buy QQQ at $25. In addition, suppose the system has automatically notified that user of the current bid. If the system is integrated with an electronic marketplace, that notification may include a mechanism (e.g. via a mouse-click) to place a complementary buy order. In this fashion, users can quickly take advantage of the recommendations they are presented with.

The use of the system and process can be further explained as follows:

User A takes action that indicates a willingness to trade a security.

Action may indicate price, quantity, hedge ratio, and buy or sell.

Examples: orders, trades, and RFQs (Request For Quote)

Model of user A is updated to reflect this new action.

Process may be configured to treat more recent actions as the most relevant or to assign equal weight to the current and past actions.

Process may be configured to ignore certain actions (e.g. very small orders) to prevent the model from being manipulated. For example, stock orders less than 1000 shares, or bond orders for less than $10,000 notional value.

Process may be configured to use certain attributes of the action (e.g. order price) in updating the model.

Updated model estimate of user A is shown to users. This may be shown with A's identity (“User A is probably willing to buy up to 10,000 shares of QQQ for $24 or less”) or anonymously (“There is a user that is probably willing to buy up to 10,000 shares of QQQ for $24 or less”).

Process may be configured to filter estimates based upon their relevance to the current market. In this way, user A's estimate is only shown if it is likely to be acted upon.

A's willingness (By “willingness” it is meant A's model estimate) to participate (as indicated by this most recent action) is compared to other models.

For each model of user B, A's willingness is compared to the current model estimate.

If the estimate for user B complements the current action of A, then user B is notified.

Notification occurs in such a way that it captures B's attention.

As part of the notification, each user B is offered an opportunity to react to the original action taken by A. (For example, by placing an order on the opposite side of the market.)

Model of A's behavior continues to be updated over time. For example, process updates A's model based upon new orders and trades for A. Process may also slowly degrade A's model over time (that is, make the price associated with A's model less aggressive) to account for decreasing accuracy of date over time.

Updates are based upon changing market conditions.

Process may be configured (as an optimization) to ignore very small changes in market conditions.

Updates occur independently of future action taken by A.

Complementary estimates (e.g. an estimate which indicates that user A may be willing to buy at $25 and another estimate user B maybe willing to sell at $25) result in notifications to participants acting as brokers.

Note that this process can be generalized to account not only for willingness to trade but also dissatisfaction with the current market or inaccuracy of the current model estimate. This negative feedback, when provided by the user, could be used, as above, to update the model estimate and to give a more accurate prediction of the user's behavior. Two examples are pulling out of the market (canceling ones own order) and indicating “no interest” in an existing order from another party. In the case of a canceled order, the system might simply disregard the order from future model calculations. In the case of an indication of “no interest,” the system might either erase the user's model estimate entirely, or degrade the user's price estimate by a fixed dollar amount, where such an amount is associated with each security (e.g. we change A's price estimate from “buy at $24 or better” to “buy at $23.50” or better).

### EXAMPLE

Alice has placed the following orders for the security QQQ. The orders are listed with the oldest order first:

buy 2000 shares at $27

buy 1000 shares at $24

buy 1000 shares at $22

Using a weighted-average model, Alice's ideal price to buy QQQ would be $25.

Using a time-weighted scale (where the first order that appears on our list is the oldest and we give 10% more weight to each successive order), Alice's ideal price might be $24.20, computed from (2000*$27*0.9+1000*24*1.0+1000*$22*1.1)/(2000+1000+1000). Alternatively, the system might use a different mathematical formulae to calculate Alice's ideal price.

In either case, however, we need to use current market conditions to adjust Alice's ideal price. Say that we recorded the following prices of the security RRR at times corresponding to when Alice placed her orders: $9, $8 and $7.33. From this data we might conclude that Alice's trades QQQ at a price that is three times the price of RRR.

The system might also use a wider range of orders to calculate such a “price ratio,” including orders from participates other than Alice.

In either case, say that the price of RRR is $7. Then according to our previous observations, Alice might buy QQQ at $21. The system might conclude that Alice's adjusted ideal price is $23, the average of the historical data ($25) and the RRR-price based estimate. In this case, the system used a 50/50 weighting in computing the average; the system might also use a different weighting, for example 40 (historical)/60 (RRR-based), yielding $23.40.

The historical data used in price estimates might also include trades. If Alice purchased 1000 shares of QQQ for $22 dollars, we might also include this value in the overall estimate, yielding ($25+$21+$22)/3=$22.67.

With Alice's estimated price in hand (for the rest of the example the system will use $22.67), we can now consider the following actions:

For a market participant such as a broker, it may be useful to know the price at which Alice is likely to buy QQQ. When the broker has expressed some interest in QQQ (for example, by viewing either current orders in QQQ or the broker's current position in QQQ), This is assuming that the system and process of an embodiment of the invention is integrated with an electronic marketplace and has access to past transactions. The system can present a list of potential QQQ buyers with the highest (i.e. most aggressive) price ranked first. It might filter this list by first determining (via some traditional analytic mechanism) the current value of QQQ and then only displaying potential buyers and sellers within some range of this value.

After using a similar process to conclude that Bob is likely to sell QQQ at a price of $22, we might electronically send a notifications to both Alice and Bob. These notifications would be intended to capture both Alice's and Bob's attention (e.g. an “instant message”) and would inform each that there was another compatible participant in the marketplace and possibly of the predicted price and/or quantity of a transaction.

In addition to informing Alice and Bob, we present each with an option to quickly place new orders in the marketplace that complement each other. For example, the system would present Bob with the option to submit an order to sell QQQ at $22.67 and Alice with an option to submit an order to buy QQQ at $23. Because the system has already identified the few willing participants in this marketplace (Alice and Bob), there is no reason that either Alice or Bob should make these new orders visible to the entire marketplace. Instead, the system can utilize an electronic price-discrimination mechanism (such as Multi-tier Orders) to offer Alice and Bob a safer way to negotiate a new trade. Even if we do not disclose the identities of Alice and Bob, we can still allow both Alice and Bob to place new orders that use a price-discrimination mechanism anonymously (for example, by identifying Bob only as “a participant willing to sell QQQ at $22”).

The Real-Time Recommendations system of one embodiment of the invention can also might send such notifications even if Bob's estimated price is $23, if it has determined that $22.67 and $23 are “reasonably” close to each other (either based upon user-entered parameters or observations of market movement over time, e.g. if $23−$22.67=$0.33 is less than 10% of the weighted average price of the more recent 10 trades in QQQ).

If there is another participant, Carol, who has an *open* order to sell QQQ at $22, we might send a notification (as described above) to Alice to bring her attention to the marketplace. Again, the system might also send this notification if Carol has an open offer at $23; that is, even if Carol's price is above Alice's. Again, along with a recommendation, it can present Alice with an option to enter a new order and immediately trade with Carol (no new action is required on Carol's behave, since she has already expressed her intent with an active, open order.)

If another participant, Dave, is using a (i.e. a system that racks the transactions of a given user or group of users working together and computes the net holdings of that user or group of users) and that system has indicated that Dave is long in QQQ, then the system might send some notification to Dave to indicate that there is an opportunity to shorten his position by selling some QQQ to Alice. (It might filter such notifications based upon our calculation of the current market value of QQQ.)

For example, say Dave owns 20,000 shares of QQQ and has determined (by some other means) that his portfolio is exposed to significant risk of a loss in value caused by a drop in the price of QQQ. That is, given the rest of the composition of his portfolio, Dave would like to be holding only 10,000 shares of QQQ. Once we have determined Alice to be a likely buyer of QQQ, the system can notify Dave of the opportunity to sell his QQQ shares to Alice. Once again, in addition to a recommendation, we can present Dave with the opportunity to enter a new order (possibly one which is only visible to Alice) to more actively solicit Alice to enter the marketplace. In this case, Dave would have the option to enter an order to sell 10,000 shares of QQQ at $22.67. This represents the quantity that Dave would like to remove from his portfolio and the price that the system has determined that Alice will participate.

Note that in the above paragraphs, the term “system” has been used to describe operations that, in general, are performed using computers and computer network. However, some steps, such as deciding whether to actually notify a potential participant of the existence of another potential participant may involve human intervention. For instance, a broker may make the final decision as to whom to notify and when.

### Operative Environment

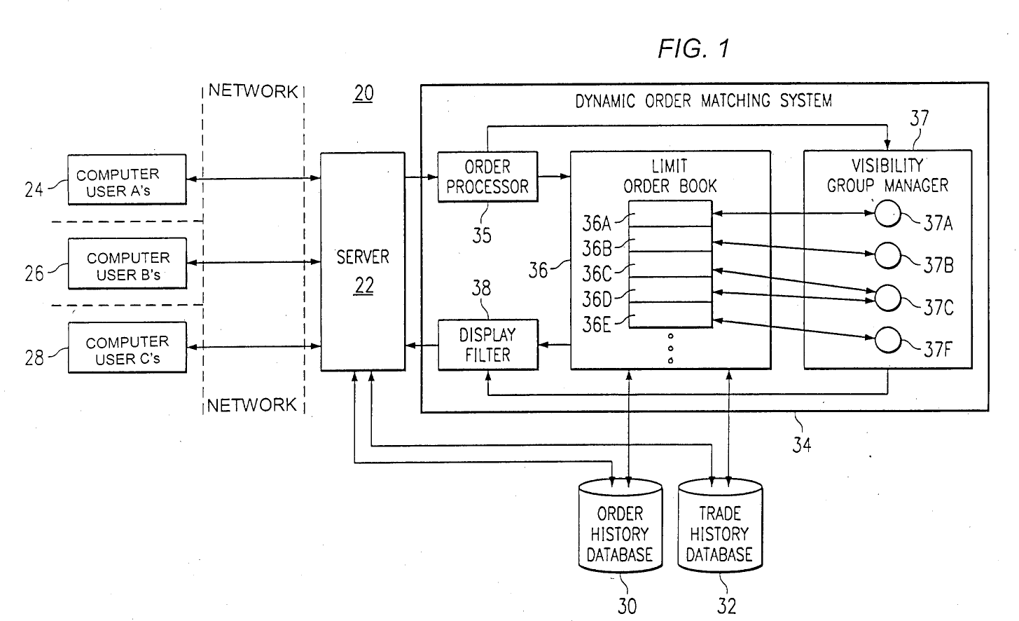

A network for one system to implement the present invention is illustrated in FIG. 1. A system 20 has a web server 22, which works through the Internet for connection with user browsers such as 24, 26 and 28. The present invention may utilize several data files including an order history database 30 and a trade history database 32 which are connected to the web server 22. A dynamic order matching system 34 is included in the system 20 for dynamically matching orders that are entered into the system 20, and for controlling display of these orders on web browsers 24, 26, and 28. A dynamic order matching system is described in commonly owned U.S. patent application Ser. No. 09/386,436, entitled Dynamic Order Visibility System for the Trading of Assets, which is expressly incorporated herein in its entirety by this reference. The system 20 enables users to place orders (buy or sell) through their web browsers and specify a visibility group of other system users (market participants) who will have access to the order. Further databases, order matching and definitions of visibility groups are described below in detail.

The dynamic order matching system 34 includes an order processor 35 that is connected to the web server 22. The other processor 35 can be programmed to implement real-time recommendations in accordance with the invention. The processor 35 is further connected to a limit order book 36 and a visibility group manager 37. A display filter 38 is connected to the limit order book 36, the visibility manager 37 and to the web server 22. The function of the display filter 38 is to insure that a given order is made available only to the participants in a selected visibility group. Therefore, it is responsible for constructing the complete list of visible orders for each user.

The limit order book 36 includes specific orders 36A, 36B, 36C, 36D and 36E. Visibility groups, which are designated sets of participants, are included in the visibility group manager 37 as 37A, 37B, 37C and 37F. Order 36A is associated with visibility group 37A, order 36B is associated with visibility group 37B and both of the orders 36C and 36D are associated with the visibility group 37C. Order 36E is associated with visibility group 37F.

The order database 30 and trade history database 32 are further coupled to the limit order book 36.

The dynamic order matching system 34 and its included components, together with the databases 30 and 32, can be implemented in either a single processing system or a distributed system of processors.

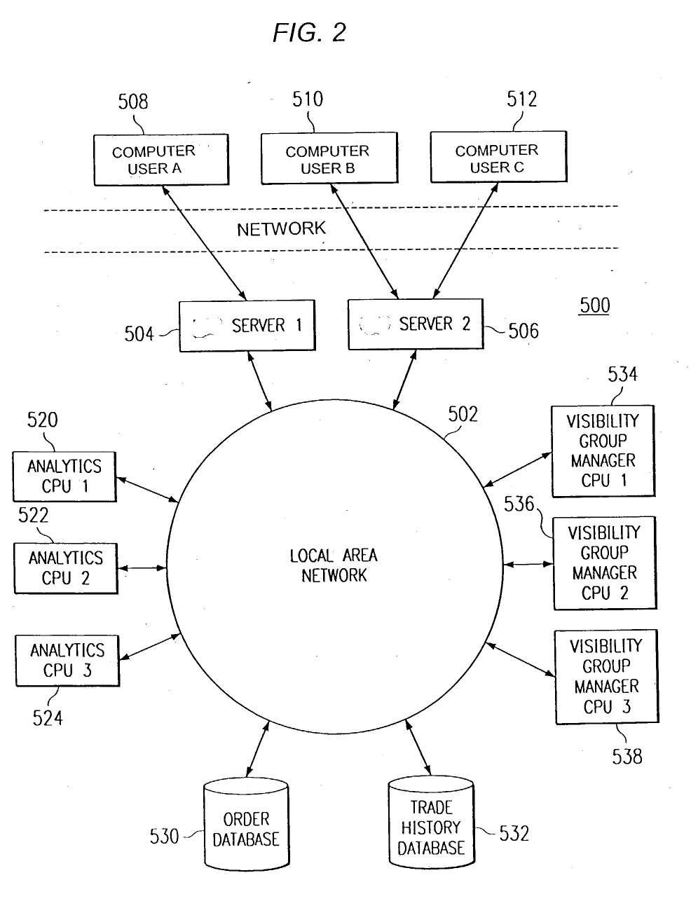

A network 500 in accordance with the present invention is shown in FIG. 2. This works with the Internet and has user browsers 508, 510 and 512 which correspond to the user browsers shown in FIG. 1.

A network 500 has web servers 504 and 506 that interconnect the local area network 502 through the Internet to each of the web browsers 508, 510 and 512.

Three analytic engines 520, 522 and 524 connect to the local area network 502. The analytics engines can be programmed to implement real-time recommendations in accordance with the invention. In this example, these correspond to the analytic engines 39A, 39B and 39C shown in FIG. 2. In other configurations, however, there might be multiple analytics engines per CPU, or multiple CPUs per analytics engine. An order database 530 corresponds to the database 30 shown in FIG. 1 and a trade history database 532 corresponds to the database 32 shown in FIG. 1. The network 500 includes three visibility group managers 534, 536 and 538 for generating visibility groups. Although network 500 is a representative hardware configuration of the present invention, the distribution of functions and data storage can be arranged in many different configurations as needed and as determined by the availability of resources for implementing the functions required for the present invention.

It will be understood that the foregoing description and drawings of preferred embodiments in accordance with the present invention are merely illustrative of the principles of the invention. Various modifications can be made by those skilled in the art without departing from the spirit and scope of the invention.

1. A computer-implemented method of finding a complementary set of parties to begin a negotiation for a trade in an item comprising:
creating respective user models, based upon one or more external market factors, to respectively predict behavior of one or more respective users with respect to participation in a transaction in the item;
evaluating current external market conditions with respect to the item;
based upon respective user models and results of the current external market evaluation, respectively predicting respective current conditions in which respective users are likely to participate in transactions in the item;
identifying respective users with respective complementary current conditions;
notifying at least one respective user of the existence of at least one other user predicted to currently be likely to be willing to participate in a transaction in the item on conditions that are complementary to conditions on which such at least one notified user is likely to be willing to participate in a transaction in the item.
